(19) United States
(12) Patent Application Publication
(10) Pub. No.: US 2023/0053308 A1
(43) Pub. Date: Feb. 16, 2023

(54) SIMULATION OF LIKENESSES AND MANNERISMS IN EXTENDED REALITY ENVIRONMENTS

(71) Applicant: AT&T Intellectual Property I, L.P., Atlanta, GA (US)

(72) Inventors: Eric Zavesky, Austin, TX (US); James Jackson, Austin, TX (US); James Pratt, Round Rock, TX (US)

(21) Appl. No.: 17/402,294

(22) Filed: Aug. 13, 2021

(51) Int. Cl. G06K 9/00

(52) U.S. Cl. CPC G06K 9/00744; G06K 9/00369; G06K 9/00335

(57) ABSTRACT

In one example, a method performed by a processing system including at least one processor includes obtaining video footage of a first subject, creating a profile for the first subject, based on features extracted from the video footage, obtaining video footage of a second subject different from the first subject, adjusting movements of the second subject in the video footage of the second subject to mimic movements of the first subject as embodied in the profile for the first subject, to create video footage of a modified second subject, verifying that the video footage of the modified second subject is consistent with a policy specified in the profile for the first subject, and rendering a media including the video footage of the modified second subject when the video footage of the modified second subject is consistent with the policy specified in the profile for the first subject.

The present disclosure relates generally to extended reality (XR) systems, and relates more particularly to devices, non-transitory computer-readable media, and methods for simulating likenesses and mannerisms in XR environments.

### BACKGROUND

Extended reality (XR) is an umbrella term that has been used to refer to various different forms of immersive technologies, including virtual reality (VR), augmented reality (AR), mixed reality (MR), cinematic reality (CR), and diminished reality (DR). Generally speaking, XR technologies allow virtual world (e.g., digital) objects to be brought into “real” (e.g., non-virtual) world environments and real world objects to be brought into virtual environments, e.g., via overlays or other mechanisms. XR technologies may have applications in fields including architecture, sports training, medicine, real estate, gaming, television and film, engineering, travel, and others. As such, immersive experiences that rely on XR technologies are growing in popularity.

### SUMMARY

In one example, the present disclosure describes a device, computer-readable medium, and method for simulating likenesses and mannerisms in extended reality (XR) environments. For instance, in one example, a method performed by a processing system including at least one processor includes obtaining video footage of a first subject, creating a profile for the first subject, based on features extracted from the video footage, obtaining video footage of a second subject different from the first subject, adjusting movements of the second subject in the video footage of the second subject to mimic movements of the first subject as embodied in the profile for the first subject, to create video footage of a modified second subject, verifying that the video footage of the modified second subject is consistent with a policy specified in the profile for the first subject, and rendering a media including the video footage of the modified second subject when the video footage of the modified second subject is consistent with the policy specified in the profile for the first subject.

In another example, a non-transitory computer-readable medium stores instructions which, when executed by a processing system, including at least one processor, cause the processing system to perform operations. The operations include obtaining video footage of a first subject, creating a profile for the first subject, based on features extracted from the video footage, obtaining video footage of a second subject different from the first subject, adjusting movements of the second subject in the video footage of the second subject to mimic movements of the first subject as embodied in the profile for the first subject, to create video footage of a modified second subject, verifying that the video footage of the modified second subject is consistent with a policy specified in the profile for the first subject, and rendering a media including the video footage of the modified second subject when the video footage of the modified second subject is consistent with the policy specified in the profile for the first subject.

In another example, a device includes a processing system including at least one processor and a computer-readable medium storing instructions which, when executed by the processing system, cause the processing system to perform operations. The operations include obtaining video footage of a first subject, creating a profile for the first subject, based on features extracted from the video footage, obtaining video footage of a second subject different from the first subject, adjusting movements of the second subject in the video footage of the second subject to mimic movements of the first subject as embodied in the profile for the first subject, to create video footage of a modified second subject, verifying that the video footage of the modified second subject is consistent with a policy specified in the profile for the first subject, and rendering a media including the video footage of the modified second subject when the video footage of the modified second subject is consistent with the policy specified in the profile for the first subject.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure may operate;

FIG. 2 illustrates a flowchart of an example method for simulating likenesses and mannerisms in extended reality environments in accordance with the present disclosure; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure enhances extended reality (XR) environments by providing improved simulation of likenesses and mannerisms. As discussed above, XR technologies allow virtual world (e.g., digital) objects to be brought into “real” (e.g., non-virtual) world environments and real world objects to be brought into virtual environments, e.g., via overlays or other mechanisms. Technologies have been developed that can render virtual versions of living beings such as animals and humans for XR environments; however, while these technologies may be able to realistically simulate the likenesses of living beings, they are less adept at simulating the movements of living beings.

The inability to convincingly simulate movements and mannerisms may detract from the desired immersion that XR is designed to provide. For instance, no matter how closely a virtual rendering of a well-known actor resembles the actor, if the rendering fails to move or behave in the ways that a viewer expects the actor to move or behave, then the viewer may be more likely to detect that the rendering is a virtual or artificial object and not the actual actor.

Examples of the present disclosure create a digital “fingerprint” of a subject's mannerisms and gestures, where the subject may be a human or a non-human object that is capable of movement (e.g., an animal, a vehicle, or the like). The fingerprint can then be used to develop virtual or synthetic versions of the subject for placement in an XR environment or other media, where virtual versions of the subjects are recognizable by viewers as the corresponding subjects.

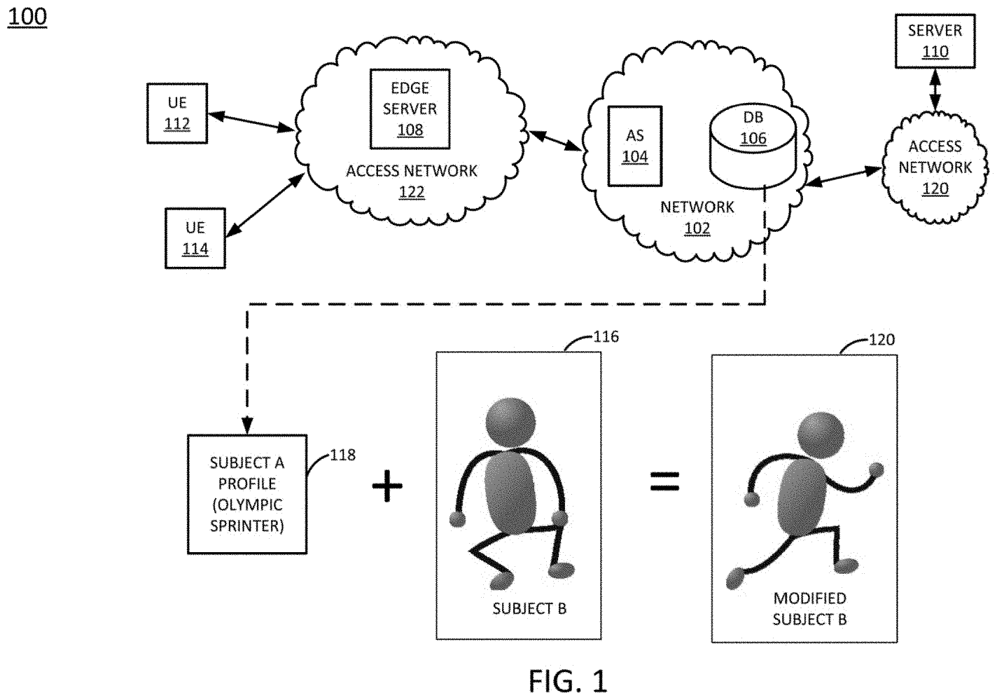

The fingerprinting process may measure, record, analyze, and reapply mannerisms of a subject so that those mannerisms can be reproduced and reused in a variety of virtual contexts. For instance, in one example, the fingerprint may be used to create a virtual replica of the subject. In another example, the fingerprints for two or more different subjects can be combined or synthesized to create a wholly new virtual subject. For instance, the new virtual subject may adopt some mannerisms (e.g., the gait) of a first subject and some mannerisms (e.g., the facial expressions) of a second subject. In further examples, the fingerprint of a first subject can be applied to a target (e.g., an actor appearing in video footage), so that the target exhibits at least some of the mannerisms for the first subject. For instance, a fingerprint of a cheetah may be applied to video footage of a human actor, so that the human actor appears to move like a cheetah. Thus, examples of the present disclosure provide a variety of use cases that facilitate creation of immersive media and that also allow subjects such as actors to monetize and control use of their likenesses and mannerisms by licensing their digital “fingerprints.” These and other aspects of the present disclosure are described in greater detail below in connection with the examples of FIGS. 1-3.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, 5G and the like related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, or an enterprise network comprising infrastructure for computing and communications services of a business, an educational institution, a governmental service, or other enterprises. The network 102 may be in communication with one or more access networks 120 and 122, and the Internet (not shown). In one example, network 102 may combine core network components of a cellular network with components of a triple play service network; where triple-play services include telephone services, Internet or data services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over internet Protocol (VoIP) telephony services. Network 102 may further comprise a broadcast television network, e.g., a traditional cable provider network or an internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video on demand (VoD) server, and so forth.

In one example, the access networks 120 and 122 may comprise broadband optical and/or cable access networks, Local Area Networks (LANs), wireless access networks (e.g., an IEEE 802.11/Wi-Fi network and the like), cellular access networks, Digital Subscriber Line (DSL) networks, public switched telephone network (PSTN) access networks, 3^{rd} party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like.

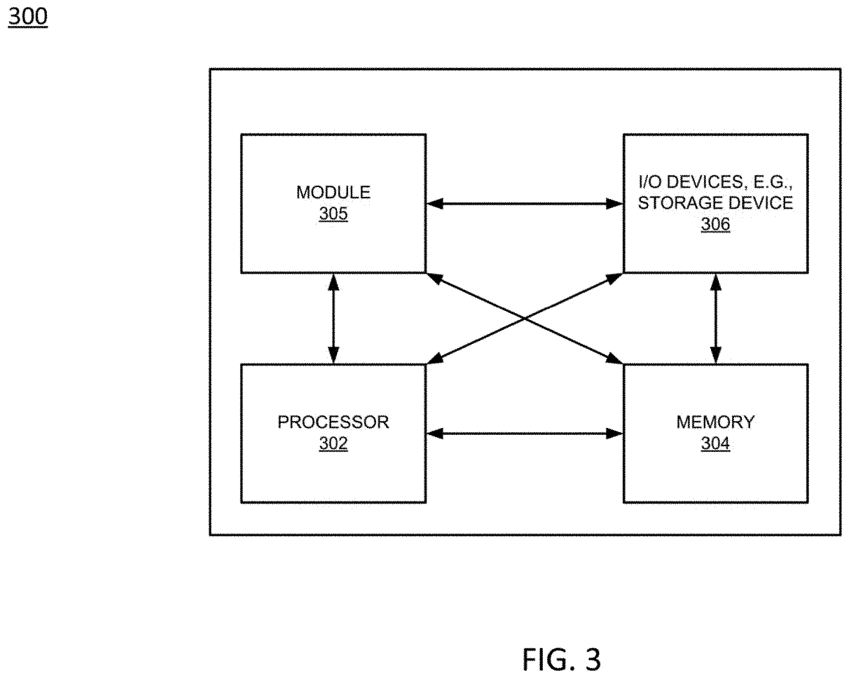

In accordance with the present disclosure, network 102 may include an application server (AS) 104, which may comprise a computing system or server, such as computing system 300 depicted in FIG. 3, and may be configured to provide one or more operations or functions in connection with examples of the present disclosure for simulating likenesses and mannerisms in extended reality environments. The network 102 may also include a database (DB) 106 that is communicatively coupled to the AS 104.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure. Thus, although only a single application server (AS) 104 and single database (DB) are illustrated, it should be noted that any number of servers may be deployed, and which may operate in a distributed and/or coordinated manner as a processing system to perform operations in connection with the present disclosure.

In one example, AS 104 may comprise a centralized network-based server for generating media content. For instance, the AS 104 may host an application that renders digital media for use in films, video games, and other immersive experiences. The application, as well as the media created suing the application, may be accessible by users utilizing various user endpoint devices. In one example, the AS 104 may be configured to create fingerprints that describe the likeness, movements, and mannerisms of various subjects and to apply those fingerprints to video footage of other subjects. For instance, the AS 104 may create a fingerprint of a first subject's likeness, movements, and mannerisms, and may then apply that fingerprint to video footage of a second subject so that the second subject mimics some of the movements or mannerisms of the first subject.

In one example, AS 104 may comprise a physical storage device (e.g., a database server), to store fingerprints for different subjects, where the subjects may include human subjects (e.g., public figures, non-public figures), animals, and non-living moving objects (e.g., vehicles). For instance, the AS 104 may store an index, where the index maps each subject to a profile containing the subject's fingerprint (e.g., characteristics of the subject's likeness, movements, and mannerisms). As an example, a subject's profile may contain video, images, audio, and the like of the subject's facial expressions, gait, voice, hand gestures, and the like. The profile may also include descriptors that describe how to replicate the facial expressions, gait, voice, hand gestures, and the like (e.g., average speed of gait, pitch of voice, etc.). A profile for a subject may also include metadata to assist in indexing and search. For instance, the metadata may indicate the subject's identity (e.g., human, animal, vehicle, etc.), occupation (e.g., action movie star, professional basketball player, etc.), identifying characteristics (e.g., unique dance move, facial expression or feature, laugh, catchphrase, etc.), pointers (e.g., uniform resource locators or the like) to media that has been modified using the subject's fingerprint, and other data. In a further example, the metadata may also identify profiles of other subjects who share similarities with the subject of the profile (e.g., other actors who look or sound like a given actor, other professional athletes who may move in a manner similar to a given professional athlete, etc.).

A profile for a subject may also specify a policy associated with the profile. The policy may specify rules or conditions under which the subject's profile may or may not be used in the creation of media content. For instance, the subject may wish to ensure that their mannerisms and movements are not used in certain types of media (e.g., genres and/or subject matter with which the subject does not want to be associated, media that expresses viewpoints with which the subject disagrees, etc.). The rules may also specify licensing fees associated with use of the subject's likeness, mannerisms, and movements, where the fees may be based on the extent to which the subject's likeness, mannerisms, and movements are used (e.g., utilizing a specific hand gesture associated with the subject may cost less than utilizing the subject's facial expressions and gait), for how long the subject's likeness, mannerisms, and movements are used (e.g., thirty seconds of use may cost less than ten minutes of use), and the context of use (e.g., utilizing the subject's mannerisms to modify a personal photo may cost less than utilizing the subject's mannerisms in a television commercial), and/or other considerations.

In a further example, the AS 104 may store video footage of various subjects. The video footage may comprise studio films, episodes of television shows, amateur videos, footage of interviews and live appearances, and other types of video footage. As discussed in further detail below, the video footage may be analyzed to create the profiles of the subjects.

In one example, the DB 106 may store the index, the profiles, and/or the video footage, and the AS 104 may retrieve the index, the profiles, and/or the video footage from the DB 106 when needed. For ease of illustration, various additional elements of network 102 are omitted from FIG. 1.

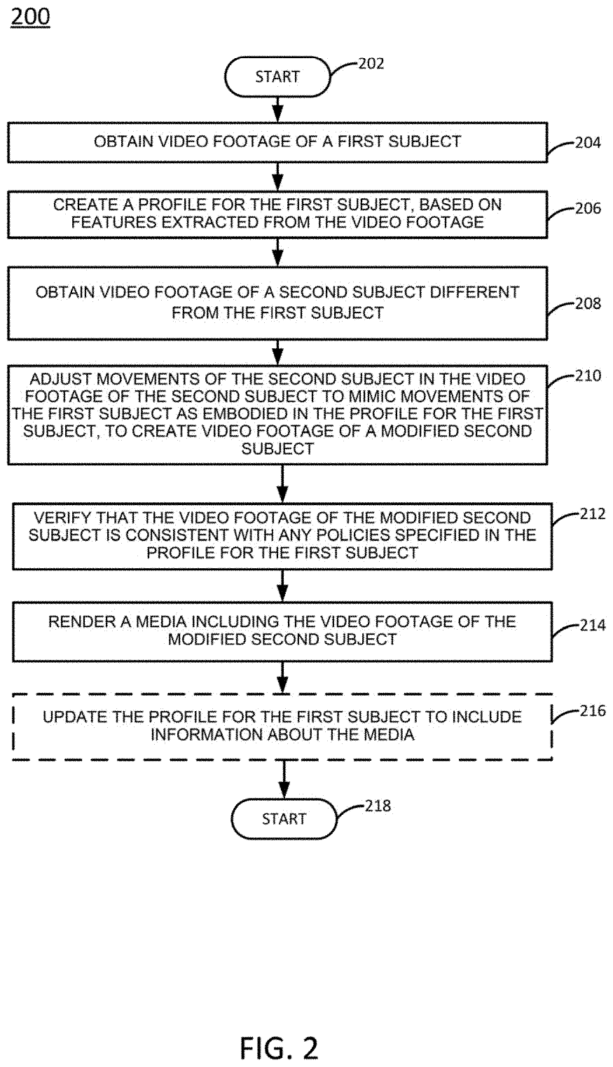

In one example, access network 122 may include an edge server 108, which may comprise a computing system or server, such as computing system 300 depicted in FIG. 3, and may be configured to provide one or more operations or functions for simulating likenesses and mannerisms in extended reality environments, as described herein. For instance, an example method 200 for simulating likenesses and mannerisms in extended reality environments is illustrated in FIG. 2 and described in greater detail below.

In one example, application server 104 may comprise a network function virtualization infrastructure (NFVI), e.g., one or more devices or servers that are available as host devices to host virtual machines (VMs), containers, or the like comprising virtual network functions (VNFs). In other words, at least a portion of the network 102 may incorporate software-defined network (SDN) components. Similarly, in one example, access networks 120 and 122 may comprise “edge clouds,” which may include a plurality of nodes/host devices, e.g., computing resources comprising processors, e.g., central processing units (CPUs), graphics processing units (GPUs), programmable logic devices (PLDs), such as field programmable gate arrays (FPGAs), or the like, memory, storage, and so forth. In an example where the access network 122 comprises radio access networks, the nodes and other components of the access network 122 may be referred to as a mobile edge infrastructure. As just one example, edge server 108 may be instantiated on one or more servers hosting virtualization platforms for managing one or more virtual machines (VMs), containers, microservices, or the like. In other words, in one example, edge server 108 may comprise a VM, a container, or the like.

In one example, the access network 120 may be in communication with a server 110. Similarly, access network 122 may be in communication with one or more devices, e.g., user endpoint devices 112 and 114. Access networks 120 and 122 may transmit and receive communications between server 110, user endpoint devices 112 and 114, application server (AS) 104, other components of network 102, devices reachable via the Internet in general, and so forth. In one example, either or both of user endpoint devices 112 and 114 may comprise a mobile device, a cellular smart phone, a wearable computing device (e.g., smart glasses, a virtual reality (VR) headset or other types of head mounted display, or the like), a laptop computer, a tablet computer, or the like (broadly an “XR device”). In one example, either or both of user endpoint devices 112 and 114 may comprise a computing system or device, such as computing system 300 depicted in FIG. 3, and may be configured to provide one or more operations or functions in connection with examples of the present disclosure for simulating likenesses and mannerisms in extended reality environments.

In one example, server 110 may comprise a network-based server for generating digital media. In this regard, server 110 may comprise the same or similar components as those of AS 104 and may provide the same or similar functions. Thus, any examples described herein with respect to AS 104 may similarly apply to server 110, and vice versa. In particular, server 110 may be a component of a system for generating media content which is operated by an entity that is not a telecommunications network operator. For instance, a provider of an XR system may operate server 110 and may also operate edge server 108 in accordance with an arrangement with a telecommunication service provider offering edge computing resources to third-parties. However, in another example, a telecommunication network service provider may operate network 102 and access network 122, and may also provide a media content generation system via AS 104 and edge server 108. For instance, in such an example, the media content generation system may comprise an additional service that may be offered to subscribers, e.g., in addition to network access services, telephony services, traditional television services, and so forth.

In an illustrative example, a media content generation system may be provided via AS 104 and edge server 108. In one example, a user may engage an application on user endpoint device 112 to establish one or more sessions with the media content generation system, e.g., a connection to edge server 108 (or a connection to edge server 108 and a connection to AS 104). In one example, the access network 122 may comprise a cellular network (e.g., a 4G network and/or an LTE network, or a portion thereof, such as an evolved Uniform Terrestrial Radio Access Network (eUTRAN), an evolved packet core (EPC) network, etc., a 5G network, etc.). Thus, the communications between user endpoint device 112 and edge server 108 may involve cellular communication via one or more base stations (e.g., eNodeBs, gNBs, or the like). However, in another example, the communications may alternatively or additional be via a non-cellular wireless communication modality, such as IEEE 802.11/Wi-Fi, or the like. For instance, access network 122 may comprise a wireless local area network (WLAN) containing at least one wireless access point (AP), e.g., a wireless router. Alternatively, or in addition, user endpoint device 112 may communicate with access network 122, network 102, the Internet in general, etc., via a WLAN that interfaces with access network 122.

In the example of FIG. 1, user endpoint device 112 may establish a session with edge server 108 for accessing an application to modify an item of digital media. For illustrative purposes, the item of digital media may be a film being produced by an independent film studio. In this regard, an employee of the film studio may be tasked with editing several frames of video footage (one representative frame of which is illustrated at 116 in FIG. 1). The video footage may comprise a film of an actor (Subject B in FIG. 1) who is portraying an actual Olympic sprinter (Subject A in FIG. 1). The employee may obtain a profile 118 for the actual Olympic sprinter, where the profile stores a fingerprint of the actual Olympic sprinter's likeness, movements, and mannerisms, including the actual Olympic sprinter's gait while running. The stored information about the gait may be applied to the video footage of the actor to produce modified video footage (one representative frame of which is illustrated at 120 in FIG. 1). In the modified video footage, the actor's gait may be modified to resemble the gait of the actual Olympic sprinter, thereby enhancing the realism of the actor's portrayal.

In other examples, the video footage might be footage from a movie sequel or reboot, where the original movie was filmed twenty years ago. In this case, Subject B may be an actor who appeared in the original movie, and the video footage may depict Subject B in the present day. Subject A in this case may be the same actor but twenty years younger, e.g., such that the profile 118 for Subject A contains the actor's own likeness, mannerisms, and movements from twenty years earlier. The video footage of the actor may be digitally modified to look and move like the actor looked and moved twenty years earlier.

In another example, the video footage may comprise video game footage of a human character (Subject B), while the profile 118 may contain the likeness and movements of a tiger (Subject A). The video game footage could be digitally modified so that the human character's movements mimic the movements of a tiger. Further examples of use are discussed in greater detail below.

It should also be noted that the system 100 has been simplified. Thus, it should be noted that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102, access networks 120 and 122, and/or Internet may comprise a content distribution network (CDN) having ingest servers, edge servers, and the like for packet-based streaming of video, audio, or other content. Similarly, although only two access networks, 120 and 122 are shown, in other examples, access networks 120 and/or 122 may each comprise a plurality of different access networks that may interface with network 102 independently or in a chained manner. In addition, as described above, the functions of AS 104 may be similarly provided by server 110, or may be provided by AS 104 in conjunction with server 110. For instance, AS 104 and server 110 may be configured in a load balancing arrangement, or may be configured to provide for backups or redundancies with respect to each other, and so forth. Thus, these and other modifications are all contemplated within the scope of the present disclosure.

To further aid in understanding the present disclosure, FIG. 2 illustrates a flowchart of a method 200 for simulating likenesses and mannerisms in extended reality environments in accordance with the present disclosure. In particular, the method 200 provides a method by which a digital fingerprint of a subject may be created and applied to create an XR media. In one example, the method 200 may be performed by an XR server that is configured to generate XR environments, such as the AS 104 or server 110 illustrated in FIG. 1. However, in other examples, the method 200 may be performed by another device, such as the processor 302 of the system 300 illustrated in FIG. 3. For the sake of example, the method 200 is described as being performed by a processing system.

The method 200 begins in step 202. In step 204, the processing system may obtain video footage of a first subject. In one example, the first subject may be a public figure, such as an actor, an athlete, a musician, a politician, a fictional character, or the like. Thus, a great deal of video footage of the first subject may exist. However, in other examples, the first subject may not be a public figure. In a further example, the first subject may be a non-human subject that is capable of movement, such as an animal, a vehicle, a cartoon character, or the like.

In one example, the video footage may comprise any type of moving imaging footage format, including two-dimensional video, three-dimensional video, and video formats that are utilized in extended reality immersions such as volumetric video (which may contain volumetric or point cloud renderings of a whole or part of a human or non-human first subject), thermal video, depth video, infrared video (e.g., in which typical optical details of a likeness are not captured, but speed or temperature readings are captured), egocentric 360 degree video (i.e., video captured from the perspective of the first subject which also includes environmental interactions around the first subject), high- or low-speed (e.g., time lapse) variations of any of the foregoing video formats (e.g., video captured from specialized cameras utilized in nature or scientific recordings of wildlife), and other types of video footage. The video footage may include partial captures of a human or non-human first subject, such as the legs, arms, face, and the like, where a specific mannerism (or a range of mannerisms) is captured in the footage.

In one example, the video footage may be obtained from a variety of sources. For instance, where the first subject is an actor, the video footage may include footage from movies and television shows in which the actor has appeared, awards shows and interviews at which the actor has been a guest, amateur video footage (e.g., videos uploaded to social media), and the like. Where the first subject is not a public figure, the video footage may include amateur video footage (e.g., videos uploaded to social media, homes movies, and the like), personal video footage (e.g., professionally produced video footage such as video of a wedding or other event), and the like. The sources of the footage may include movie and television studio databases, public domain databases, social media, streaming media databases, and other sources.

In step 206, the processing system may create a profile for the first subject, based on features extracted from the video footage. For instance, in one example, the processing system may use some sort of reference frame or template (e.g., a body or skeleton template, or a representative performance by the first subject) as a reference to detect differences in the first subject's movements and articulation in the video footage. The detected differences may be embodied in the profile, which models the mannerisms and movements of the first subject. The mannerisms may include, for instance, facial expressions that the first subject frequently makes, the first subject's gait, distinctive hand gestures that the first subject makes, distinctive body language of the first subject, and other mannerisms.

In a further example, the profile may further include audio effects. For instance, the profile may include samples or characteristics of the first subject's voice and/or any vocalizations associated with the first subject (e.g., a distinctive laugh, a catchphrase, or the like, or a growl, a chirp, a bark or the like where the first subject is an animal).

In a further example, creating the profile may also involve setting a policy associated with the profile. The policy may specify rules or conditions under which the first subject's profile may or may not be used in the creation of media content. For instance, the first subject may wish to ensure that their mannerisms and movements are not used in certain types of media (e.g., genres and/or subject matter with which the first subject does not want to be associated, media that expresses viewpoints with which the subject disagrees, etc.). The rules may also specify licensing fees associated with use of the first subject's mannerisms and movements, where the fees may be based on the extent to which the first subject's mannerisms and movements are used (e.g., utilizing a specific hand gesture associated with the first subject may cost less than utilizing the first subject's facial expressions and gait), for how long the first subject's mannerisms and movements are used (e.g., thirty seconds of use may cost less than ten minutes of use), and the context of use (e.g., utilizing the first subject's mannerisms to modify a personal photo may cost less than utilizing the first subject's mannerisms in a television commercial), and/or other considerations.

In step 208, the processing system may obtain video footage of a second subject different from the first subject. In one example, the second subject may be a human subject. In another example, however, the second subject may be a virtual subject, such as an avatar of a human user. The video footage of the second subject may be obtained from any of the same sources as the video footage of the first subject.

In step 210, the processing system may adjust the movements of the second subject in the video footage of the second subject to mimic movements of the first subject as embodied in the profile for the first subject, to create video footage of a modified second subject. Thus, the second subject may retain the appearance of the second subject (e.g., facial features, body shape, etc.), but may now move with the movements of the first subject. It should be noted, however, that in other examples, the appearance (e.g., facial features, body shape, etc.) and/or the sound (e.g., voice or other vocalizations) of the first subject may additionally or alternatively be modified to resemble the appearance and/or sound of the first subject.

For instance, in one example, the processing system may break down the macro-movements of the second subject from the video footage of the second subject into micro-movements. In one example, a “macro-movement” of a subject is understood to refer to a movement that is made up of smaller “micro-movements.” For instance, the rotation or translation of a knee may be a micro-movement that contributes to the macro-movement of the knee's flexion or extension. Once the macro-movements of the second subject have been broken down into micro-movements, the processing system may programmatically fit the movements of the first subject to the micro-movements of the second subject.

In one example, the processing system may utilize an approach that is commonly used in computer animation called kinematics. In kinematics, the macro movements of a subject's joints or body points (e.g., hands, arms, etc.) are first pre-specified (at one point in time or at a series of points in time), and interpolation is applied to move those joints or body points to the correct location via a connected skeleton. In the present disclosure, the macro- and micro-movements may be optimized with kinematics for both computational efficiency and authenticity to the video footage of the second subject. In another example, a method referred to as video motion augmentation may be used. In video motion augmentation, smaller movements (e.g., a swagger, a squint, a smile, or the like) may be analyzed and emphasized to be more dramatic and to better match the original motions in the video footage of the first subject. With this execution, what is originally captured as a bad impersonation of a particular actor or movement can be adapted (via augmentation or suppression) to present a more dramatic or authentic display of activity. Examples of video motion augmentation techniques which may be utilized according to the present disclosure are described in greater detail in U.S. Pat. No. 10,448,094.

In one example, adjusting the movements of the second subject in accordance with step 210 may be performed in response to a request from a user of the processing system. For instance, the user may be a content creator who is creating a new item of media content (e.g., a film, a short video, a video game, or the like). In one example, the use may search an index of subject profiles in order to locate profiles for subjects who are known to exhibit desired traits (e.g., a funny laugh, a unique dance move or facial expression, or the like). In another example, the user may search the index in order to locate the desired traits, without necessarily having knowledge of a specific subject who may exhibit the desired traits.

In one example, adjusting the movements of the second subject in accordance with step 210 may involve receiving human feedback on programmatic adjustments. For instance, a human user who has requested adjustment of the second subject's movements to mimic the first subject's movements may provide feedback indicating whether the resultant adjustments are satisfactory. In this case, the human user may be the creator of a new media asset (e.g., a film or the like). If the resultant adjustments are not satisfactory, the human user may provide some indication as to what aspects of the resultant adjustments may require further adjustment (e.g., the second subject's gait is too quick, the second subject's facial expression is too exaggerated, etc.). In a further example, feedback may also be received from the first subject and/or the second subject.

In step 212, the processing system may verify that the video footage of the modified second subject is consistent with any policies specified in the profile for the first subject. For instance, as discussed above, the profile for the first subject may specify limitations on or conditions of use of the first subject's likeness, movements, and mannerisms. Thus, the processing system may verify that the manner in which the first subject's likeness, movements, and/or mannerisms are used by the modified second subject is permitted by the first subject, as well as whether any licensing fees or other conditions of use have been satisfied.

If the modified second subject is for any reason not consistent with any of the policies specified in the profile for the first subject, then step 210 may be repeated, making one or more changes in order to produce video footage of a modified second subject that is more likely to be consistent with the policies specified in the profile for the first subject. For instance, if the profile for the first subject specifies that the first subject's likeness may not be used for a villainous character, and the modified second subject is a villainous character, then step 210 may be repeated using the likeness of a third subject (i.e., a person who is different from the first subject) who may bear some resemblance to the first subject.

In step 214, assuming that the video footage of the modified second subject is consistent with any policies specified in the profile for the first subject, the processing system may render a media including the video footage of the modified second subject. In one example, the media may be a film (e.g., a studio film, a student film, etc.), a video (e.g., an amateur video uploaded to social media), a video game, or another immersive or extended reality experience. The video footage of the modified second subject may thus appear in the media. Where the media is a video game or interactive or immersive experience, rendering the video footage of the modified second subject may involve allowing users to interact with the modified second subject (e.g., to have conversations with the modified second subject, to carry out tasks involving the modified second subject, and the like). Thus, in some examples, the rendering may be performed in real time, as a user is experiencing the media (e.g., as in the case of a game-based interaction).

In optional step 216 (illustrated in phantom), the processing system may modify the profile for the first subject to include information about the media. For instance, the profile for the first subject may be modified to indicate what aspects of the first subject's likeness, movements, and/or mannerisms were used to create the video footage of the modified second subject which is included in the media, as well as details of the use (e.g., which film, video game, or the like the video footage of the modified second subject appears in, the amounts of any fees paid to the first subject for the use, and the like).

The method 200 may end in step 218.

Thus, examples of the present disclosure may create a digital “fingerprint” of a subject's mannerisms and gestures, where the subject may be a human or a non-human being or object that is capable of movement (e.g., an animal, a vehicle, or the like). The fingerprint can then be used to develop virtual or synthetic versions of the subject for placement in an XR environment or other media, where virtual versions of the subjects are recognizable by viewers as the corresponding subjects.

This ability may prove useful in a variety of applications. For instance, in one example, a character in a movie sequel or reboot may be digitally modified to move like the character moved in the earlier movies, when the actor who played the character was (possibly significantly) younger. The character's physical appearance could also be aged up or down as needed by the story. In another example, the movements of a character in a movie or video game could be digitally modified to mimic the movements of an animal, such as a tiger or a dolphin. In another example, video footage of a stunt double could be digitally modified to more closely resemble the actor who the stunt double is meant to stand in for. In another example, video footage of a stand-in could be digitally modified to make the stand-in more closely resemble an actor who may have been unavailable or unable to shoot a particular scene.

Thus, the present disclosure may reduce the costs of filming media on-site. For instance, the mannerisms of a particular actor or character may be licensed once for an entire franchise (e.g., a series of films or video games, a limited series television show, or the like). Modifications of video footage according to examples of the present disclosure can also be performed for multiple scenes or shots at the same time to speed up shooting time.

In further examples, the movements of non-human beings (e.g., animals) could be learned from video footage and used to recreate those non-human beings in a media without requiring physical access to the non-human beings. For instance, a film may include scenes of a character interacting with a potentially dangerous wild animal (e.g., a shark or a tiger). Rather than bring a trained or captive animal on set, video footage of representative instances of the animal in the wild may be examined and mined for movement data that can be used to create a generic, but realistic and wholly digital version of the animal, which may then be inserted into the film. Thus, this approach may help to minimize potentially dangerous and/or ethically problematic situations during creation of media.

Further examples of the disclosure could be applied to modernize older media and/or to convert older media to newer formats that may not have been available at the time at which the older media was created. For instance, a movie that was originally shot on 35 mm film could be converted to a volumetric video format by applying profiled movements to the characters in the film. Similarly, image enhancements could be applied to soften the effects of bad makeup or lighting, improve the realism of special effects, and the like.

In further examples, the present disclosure may have application beyond the digital realm. For instance, the movements and mannerisms of a specific character or individual could be mapped onto an animatronic figure in a theme park or the like. The mannerisms of the animatronic figure could even be adapted dynamically based on context (e.g., if the audience includes children, avoid any gestures that could be considered rude or otherwise objectionable).

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, a server (such as might be used to perform the method 200) could be implemented as illustrated in FIG. 3.

As depicted in FIG. 3, the system 300 comprises a hardware processor element 302, a memory 304, a module 305 for simulating likenesses and mannerisms in extended reality environments, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for simulating likenesses and mannerisms in extended reality environments may include circuitry and/or logic for performing special purpose functions relating to the operation of a home gateway or XR server. The input/output devices 306 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for simulating likenesses and mannerisms in extended reality environments (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for simulating likenesses and mannerisms in extended reality environments (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
obtaining, by a processing system including at least one processor, video footage of a first subject;
creating, by the processing system, a profile for the first subject, based on features extracted from the video footage;
obtaining, by the processing system, video footage of a second subject different from the first subject;
adjusting, by the processing system, movements of the second subject in the video footage of the second subject to mimic movements of the first subject as embodied in the profile for the first subject, to create video footage of a modified second subject;
verifying, by the processing system, that the video footage of the modified second subject is consistent with a policy specified in the profile for the first subject; and
rendering, by the processing system, a media including the video footage of the modified second subject when the video footage of the modified second subject is consistent with the policy specified in the profile for the first subject.

2. The method of claim 1, wherein the first subject comprises a human subject.

3. The method of claim 1, wherein the first subject comprises a non-human subject that is capable of movement.

4. The method of claim 1, wherein the profile for the first subject models the movements of the first subject.

5. The method of claim 4, wherein the profile further models at least one of: a likeness of the first subject, a sound of the first subject, or a mannerism of the first subject.

6. The method of claim 4, wherein the creating comprises detecting differences in the movements of the first subject relative to a template.

7. The method of claim 6, wherein the template comprises a body skeleton template.

8. The method of claim 1, wherein the policy specifies at least one condition that governs a use of the movements of the first subject in a creation of media content.

9. The method of claim 8, wherein the at least one condition limits at least one of: a genre with which the first subject is not to be associated, a subject matter with which the first subject is not to be associated, or an expressed viewpoint with which the first subject is not to be associated.

10. The method of claim 8, wherein the at least one condition specifies a fee for use of the movements of the first subject.

11. The method of claim 1, wherein the second subject is at least one of: a human subject or a virtual subject.

12. The method of claim 1, wherein the adjusting comprises:
breaking macro-movements of the second subject from the video footage of the second subject down into micro-movements; and
fitting the movements of the first subject to the micro-movements.

13. The method of claim 1, wherein the adjusting is performed in response to a user, and wherein the user is at least one of: the first subject, the second subject, or a creator of the media.

14. The method of claim 13, wherein the adjusting is performed using feedback from the user.

15. The method of claim 14, wherein the feedback indicates an aspect of the video footage of the modified second subject that requires further adjustment.

16. The method of claim 1, wherein the rendering is performed in real time as a user is experiencing the media.

17. The method of claim 1, wherein the media is at least one of: a studio film, a video game, an amateur video, or an immersive experience, and wherein a format of the media is at least one of: a two-dimensional video, a three-dimensional video, a volumetric video, a thermal video, a depth video, an infrared video, an egocentric 360 degree video, or high- or low-speed variations thereof.

18. The method of claim 1, further comprising:
modifying, by the processing system, the profile for the first subject to include information about the media.

19. A non-transitory computer-readable medium storing instructions which, when executed by a processing system including at least one processor, cause the processing system to perform operations, the operations comprising:
obtaining video footage of a first subject;
creating a profile for the first subject, based on features extracted from the video footage;
obtaining video footage of a second subject different from the first subject;
adjusting movements of the second subject in the video footage of the second subject to mimic movements of the first subject as embodied in the profile for the first subject, to create video footage of a modified second subject;
verifying that the video footage of the modified second subject is consistent with a policy specified in the profile for the first subject; and
rendering a media including the video footage of the modified second subject when the video footage of the modified second subject is consistent with the policy specified in the profile for the first subject.

20. A device comprising:
a processing system including at least one processor; and
a computer-readable medium storing instructions which, when executed by the processing system, cause the processing system to perform operations, the operations comprising:
obtaining video footage of a first subject;
creating a profile for the first subject, based on features extracted from the video footage;
obtaining video footage of a second subject different from the first subject;
adjusting movements of the second subject in the video footage of the second subject to mimic movements of the first subject as embodied in the profile for the first subject, to create video footage of a modified second subject;
verifying that the video footage of the modified second subject is consistent with a policy specified in the profile for the first subject; and
rendering a media including the video footage of the modified second subject when the video footage of the modified second subject is consistent with the policy specified in the profile for the first subject.
